(19) United States
(12) Patent Application Publication
(10) Pub. No.: US 2013/0317776 A1
(43) Pub. Date: Nov. 28, 2013

(54) TIME-DOMAIN DENSITY TRIGGERING IN A TEST AND MEASUREMENT INSTRUMENT

(71) Applicants: Kenneth P. DOBYNS, Beaverton, OR (US); Kristie L. VEITH, Beaverton, OR (US)

(72) Inventors: Kenneth P. DOBYNS, Beaverton, OR (US); Kristie L. VEITH, Beaverton, OR (US)

(73) Assignee: TEKTRONIX, INC., Beaverton, OR (US)

(21) Appl. No.: 13/480,294

(22) Filed: May 24, 2012

(51) Int. Cl. G06F 15/00; G01N 9/00

(52) U.S. Cl. 702/128

(57) ABSTRACT

A test and measurement instrument according to an embodiment of the present invention converts digital data that represents an analog input signal into a time-domain bitmap, and then compares a region of that time-domain bitmap to a density threshold. When the density value violates the density threshold, a trigger signal is generated that causes digital data to be stored into a memory.

### FIELD OF THE INVENTION

The present invention relates to test and measurement instruments, and more particularly to trigger circuits for test and measurement instruments.

### BACKGROUND OF THE INVENTION

Oscilloscopes use trigger circuits to detect, and thereby permit the display of, various types of signals. There are numerous kinds of trigger circuits. For example, oscilloscopes use edge triggers, pulse width triggers, serial data triggers, and so on.

In some cases, the user of an oscilloscope may want to detect an extremely subtle variation in the statistical properties of a signal. For example, the user may want to trigger when the statistical profile of a signal deviates from a Gaussian distribution. However, no conventional trigger is capable of detecting such a phenomenon.

What is needed is a way to trigger on the statistical variation of an input signal.

### SUMMARY OF THE INVENTION

A test and measurement instrument according to an embodiment of the present invention converts digital data that represents an analog input signal into a time-domain bitmap, and then compares a region of that time-domain bitmap to a density threshold. When the density value violates the density threshold, a trigger signal is generated that causes digital data to be stored into a memory.

The objects, advantages, and other novel features of the present invention are apparent from the following detailed description when read in conjunction with the appended claims and attached drawings.

### BRIEF DESCRIPTION OF THE DRAWINGS

FIG. 1 depicts a high-level block diagram of a conventional test and measurement instrument.

FIG. 2 depicts a high-level block diagram of a trigger detector according to an embodiment of the present invention.

FIG. 3 illustrates the steps of creating a time-domain bitmap according to an embodiment of the present invention.

FIG. 4 depicts a time-domain bitmap according to an embodiment of the present invention.

### DETAILED DESCRIPTION OF THE INVENTION

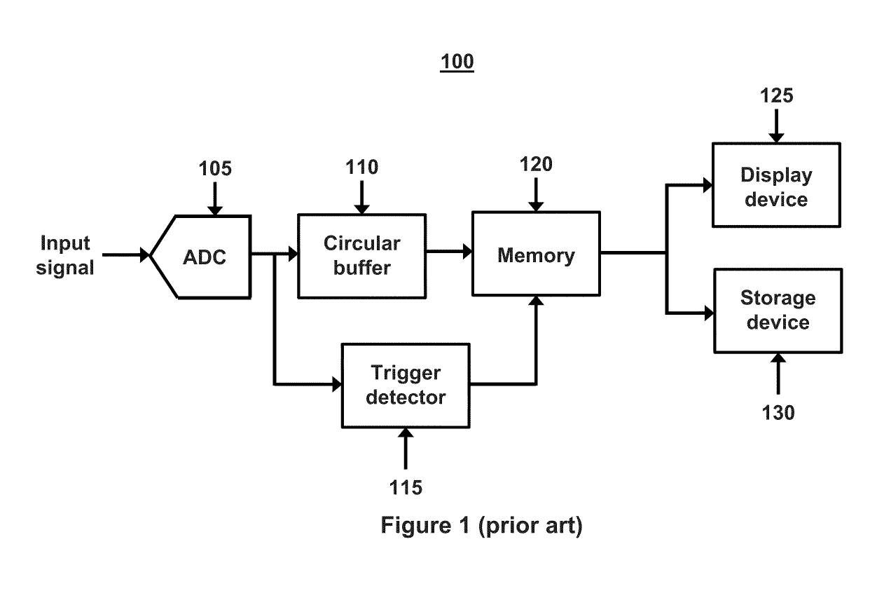

FIG. 1 depicts a conventional test and measurement instrument 100. An analog-to-digital converter (ADC) 105 receives an analog input signal and digitizes it to produce a continuous stream of digital data that represents the analog values of the input signal at the sampling instants. The digital data is input to a circular buffer 110 and also input to a trigger detector 115 that monitors the digital data for a trigger event. When a trigger event is detected, the trigger detector 115 generates a trigger signal that causes an acquisition memory 120 to store the digital data held in the circular buffer 110. The stored digital data may then be displayed on a display device 125 or stored in a storage device 130. The test and measurement instrument 100 represents any one of various test and measurement instruments such as an oscilloscope, a real-time spectrum analyzer, and the like. As such, instrument-specific elements such as pre-amplifiers, down-converters, etc. are not shown for simplicity.

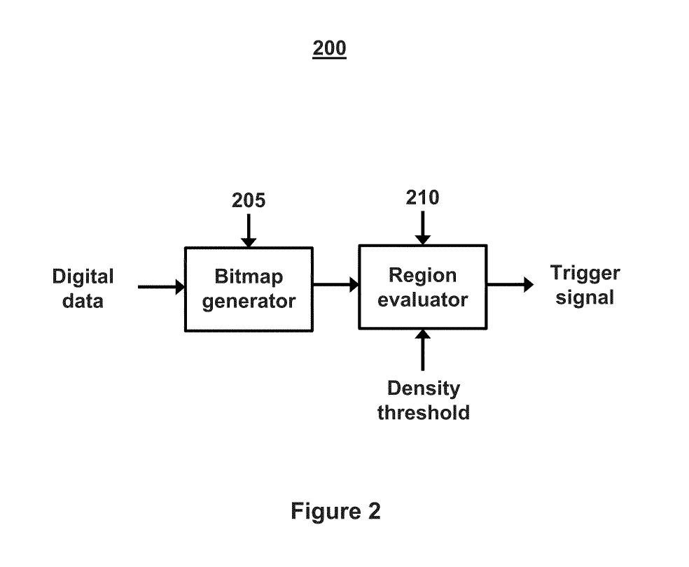

Now, in an embodiment of the present invention, a test and measurement instrument includes a trigger detector 200 as shown in FIG. 2. A time-domain bitmap generator 205 receives digital data and processes it to generate a time-domain bitmap (or simply, a bitmap). A region evaluator 210 then compares a density value of a region of the bitmap with a density threshold. When the density value violates the density threshold, the region evaluator 210 generates a trigger signal. The time-domain bitmap generator 205 and the region evaluator 210 are described in more detail below.

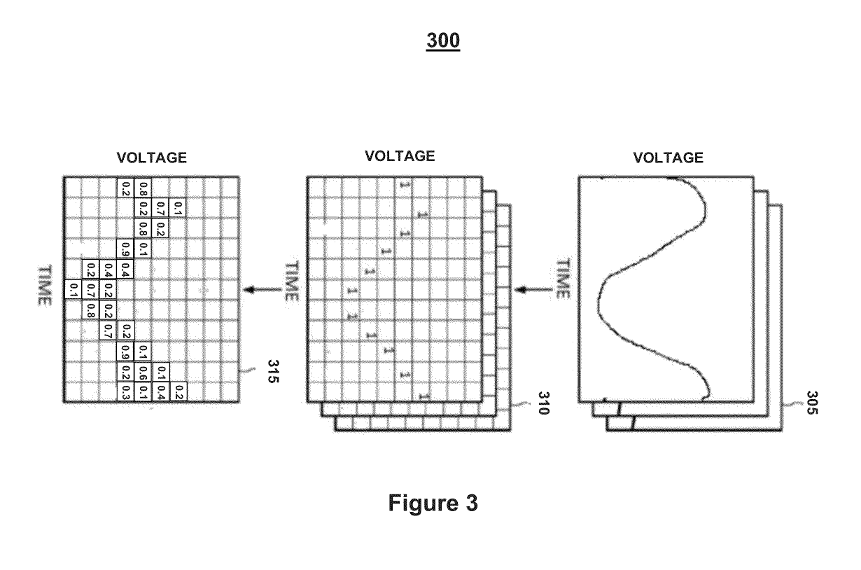

The time-domain bitmap generator 205 processes the stream of digital data to produce a bitmap as illustrated in FIG. 3. The stream of digital data is segmented into a series of waveforms 305. Each waveform 305 is rasterized to produce a rasterized waveform 310. A rasterized waveform 310 comprises a plurality of cells arranged in an array of rows and columns, with each row representing a particular voltage amplitude value and each column representing a particular time value. The value of each cell is either a “1,” also referred to as a “hit,” which indicates that the input signal was present at that particular location in voltage amplitude versus time or a “0,” which indicates that it was not. The values of the corresponding cells of the rasterized waveforms 310 are summed together and then divided by the number of waveforms to form a time-domain bitmap 315. In some embodiments, when a new bitmap is created, the previously created bitmap is discarded and replaced with the newly created bitmap. In other embodiments, newly created bitmaps are accumulated into, i.e., combined with, the previously created bitmap.

The density value of a cell equals the number of hits within the cell divided by the number of waveforms used to generate it. In other words,

$$Density value of a cell = \frac{Number of hits}{Number of waveforms}$$

The density value of a region equals the sum of the density values of all of the cells within the region divided by the number of cells bound by the region. In other words,

$$Density value of a region = \frac{Sum of density values of all cells within the region}{Number of cells bounded by the region}$$

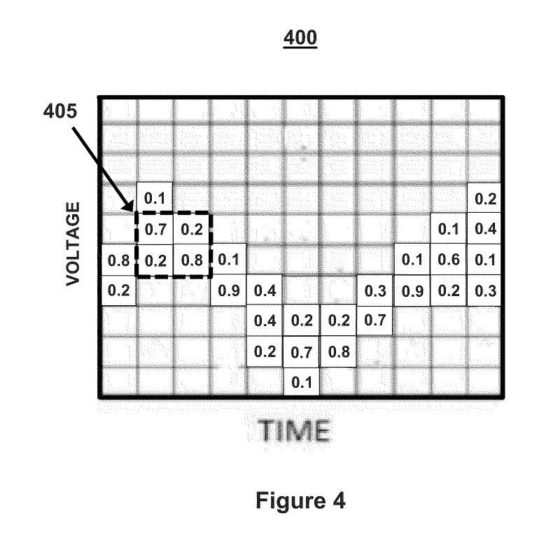

For example, consider FIG. 4 which depicts a time-domain bitmap 400 according to an embodiment of the present invention. A region 405 spans 2×2=4 cells of the bitmap 400, however, it could alternatively span any number of cells, such as 1×1 cells, 3×5 cells, and so on. The density value of the region 410 equals (0.7+0.2+0.2+0.8)=1.9/4=0.475. The region evaluator 210 compares this density value to a density threshold, and generates a trigger signal if the density value violates the density threshold. “Violate” may be programmed to mean either “exceeds” or “is less than.” So, for example, if the density threshold was 0.25, and if the region evaluator 210 was programmed to generate the trigger signal when the density value exceeds the density threshold, then the trigger signal would be generated because 0.475 exceeds 0.25. However, if the region evaluator 210 was programmed to generate the trigger signal when the density value is less than the density threshold, then the trigger signal would not be generated because 0.472 is not less than 0.25.

Using the various embodiments of the trigger detector shown and described above, a user may detect extremely subtle variations in the statistical properties of a signal, such as when the statistical profile of a signal deviates from a Gaussian distribution. For example, if the user knows that a signal having a Gaussian distribution should have a density value of 0.5 or less at a particular time and voltage location, then the user may program the trigger detector to detect when the density at that location exceeds 0.5.

In various embodiments, the location and size of the region of the bitmap may be specified by a user, specified by the test and measurement instrument, or specified by a standard. Similarly, in various embodiments, the density threshold may be defined a user, defined by the test and measurement instrument, or defined by a standard.

It will be appreciated that the various elements of the test and measurement instrument shown and described above may be implemented in hardware, software, or a combination of the two, and may comprise or be implemented on a general purpose microprocessor, a digital signal processor (DSP), an application specific integrated circuit (ASIC), a field-programmable gate array (FPGA), or the like.

It will be appreciated from the foregoing discussion that the present invention represents a significant advance in the field of test and measurement instruments. Although specific embodiments of the invention have been illustrated and described for purposes of illustration, it will be understood that various modifications may be made without departing from the spirit and scope of the invention. Accordingly, the invention should not be limited except as by the appended claims.

What is claimed is:

1. A test and measurement instrument comprising:
an analog-to-digital converter that digitizes an analog input signal to produce digital data;
a trigger detector that processes the digital data in real-time and generates a trigger signal upon the occurrence of a trigger event; and
a memory that stores digital data in response to the trigger signal;
the trigger detector comprising:
a bitmap generator that converts the digital data into a time-domain bitmap; and
a region evaluator that generates the trigger signal when a density value of a region of the time-domain bitmap violates a density threshold.

2. A test and measurement instrument as in claim 1 further comprising a display device that displays a representation of the digital data stored in the memory.

3. A test and measurement instrument as in claim 1 wherein the bitmap generator accumulates the time-domain bitmap into a previously created time-domain bitmap.

4. A test and measurement instrument as in claim 1 wherein “violates” means “exceeds.”

5. A test and measurement instrument as in claim 1 wherein “violates” means “is less than.”

6. A test and measurement instrument as in claim 1 wherein the density threshold is defined by a user.

7. A test and measurement instrument as in claim 1 wherein the density threshold is defined by the test and measurement instrument.

8. A test and measurement instrument as in claim 1 wherein the density threshold is defined by a standard.

9. A method comprising the steps of:
digitizing an analog input signal to produce digital data;
converting the digital data into a time-domain bitmap;
generating a trigger signal when a density value of a region of the time-domain bitmap violates a density threshold; and
storing digital data in a memory in response to the trigger signal.

10. A method as in claim 9 further comprising the step of displaying a representation of the digital data stored in the memory in response to the trigger signal.

11. A method as in claim 9 wherein “violates” means “exceeds.”

12. A method as in claim 9 wherein “violates” means “is less than.”

13. A method as in claim 9 wherein the density threshold is defined by a user.

14. A method as in claim 9 wherein the density threshold is defined by a test and measurement instrument.

15. A method as in claim 9 wherein the density threshold is defined by a standard.
